(19) United States
(12) Patent Application Publication
(10) Pub. No.: US 2023/0003522 A1
(43) Pub. Date: Jan. 5, 2023

(54) PIPE ALIGNMENT SYSTEM AND METHODS OF MAKING AND USING THE SAME

(71) Applicant: Thomas Mewherter, Raeford, NC (US)

(72) Inventor: Thomas Mewherter, Raeford, NC (US)

(21) Appl. No.: 17/365,040

(22) Filed: Jul. 1, 2021

(51) Int. Cl. G01C 15/00

(52) U.S. Cl. CPC G01C 15/004

(57) ABSTRACT

The presently disclosed subject matter is generally directed to an alignment device that can be used in a wide variety of situations, such as (but not limited to) the installation of pipes, conduits, and drainage fittings. The disclosed device comprises a housing defined by a central channel. A laser passes through the housing central channel and is configured to emit a beam of light in a straight or angled line, visible to the user. The laser beam can be used to accurately position pipes, drainage fittings, and the like. In some embodiments, the device includes one or more adaptors of various sizes that can releasably attach to the housing. The adaptor functions an adaptor, selected to fit a desired pipe size to allow for proper positioning of the device. Thus, in use, the housing and/or a portion of the adaptor can fit into an open end of a pipe such that the laser beam emits a beam of light indicating a projected location for a connecting pipe or conduit. In this way, the installation of a pipe is more accurate and efficient.

### TECHNICAL FIELD

The presently disclosed subject matter is generally directed to a pipe and conduit alignment system. The presently disclosed subject matter further includes methods of making and using the disclosed system.

### BACKGROUND

Pipes have long been used to transmit liquids such as drinking water, wastewater, irrigation water, sewage, chemicals, and the like from one location to another. Piping has further been used as a conduit for electrical wiring. Piping is conventionally constructed from rigid polymeric materials, such as Polyvinyl Chloride (PVC), Chlorinated Polyvinyl Chloride (CPVC), Acrylonitrile Butadiene Styrene (ABS), Polyethylene (PE), Cross-Linked Polyethylene (PEX), and the like. Piping is frequently installed in a wide variety of environments, such as within trenches in the ground, within the walls or ceiling of a building, and/or between two already fixed (but not necessarily aligned) external elements. Due to the general rigidity of the piping, care must be taken to accurately design, lay out, and connect piping. However, pipe fitting is a difficult skill to master. Particularly, due to the complex angles and narrow workspaces, there is typically a great amount of guesswork and complex measurements that must be taken to properly angle or position one pipe relative to another pipe. In addition, tape measures, levels, and other tools used in the field of construction are imprecise due to human error and limitations of the tools themselves. Tape measures, for example, can product inaccurate results at long distances due to bending or slacking of the tape. Further, because adjacent pieces of piping and their fittings are often connected permanently (e.g., via an epoxy or the like), a technician connecting the elements has little flexibility in installation path and only a single chance to make each connection correctly. It would therefore be beneficial to provide an alignment device that facilitates and streamlines the process of connecting piping and conduits.

### SUMMARY

In some embodiments, the presently disclosed subject matter is directed to a pipe alignment device. The device comprises a housing defined by a first segment comprising a front face, an opposed rear face, and a length therebetween. The housing further includes a second segment comprising a front face, an opposed rear face, and a length therebetween, wherein the second segment front face is in direct contact with the first segment rear face. The housing includes a channel that spans an interior of the housing from the first segment front face to the second segment rear face. The device comprises a laser positioned with the channel, the laser comprising a beam output positioned adjacent to the first segment front face. The device comprises an adaptor defined by a first section comprising a front face, an opposed rear face, and a length therebetween. The adaptor further comprises a second section comprising a front face, and opposed rear face, and a length therebetween, wherein the second section front face is in direct contact with the first section rear face. The adaptor further includes a central bore that an interior of the adaptor from the first section front face to the second section rear face. The first segment, second segment, first section, and second section each comprise a diameter, the first segment diameter being greater than the second segment diameter, the first section diameter being greater than the second section diameter.

In some embodiments, the pipe alignment device further includes a level.

In some embodiments, the laser is leveled within the housing channel.

In some embodiments, the second section diameter is greater than the second segment diameter.

In some embodiments, the housing first length is about 0.5 to 2 inches and the housing second length is about 0.3 to 2 inches.

In some embodiments, the first segment, second segment, first section, and second section are configured with a cylindrical shape.

In some embodiments, the channel comprises a diameter of about 0.2 to 1 inches and a length of about 0.8-4 inches.

In some embodiments, the channel comprises one or more adjusters configured to adjust the orientation of the laser within the channel, the beam of the laser, or both.

In some embodiments, the adaptor first length is about 0.1-0.8 inches.

In some embodiments, the adaptor second length is about 0.2-1 inches.

In some embodiments, the adaptor first section has a diameter of about 3-6 inches.

In some embodiments, the adaptor second section has a diameter of about 2-5 inches.

In some embodiments, the central bore comprises a diameter of about 1-4 inches.

In some embodiments, the presently disclosed subject matter is directed to a method of installing a pipe or tubing, the method comprising positioning the housing second segment of the disclosed pipe alignment device into the open mouth of a first pipe. The method includes powering the laser, whereby a laser beam is projected onto a surface in front of the first pipe. The method further includes positioning a second pipe in line with the laser beam, such that the first and second pipes are in alignment.

In some embodiments, the second segment cooperates with the open mouth of the first pipe to retain the device within the first pipe mouth.

In some embodiments, the second segment comprises an adaptor, the adaptor defined by a second segment that cooperates with the open mouth of the first pipe to retain the device within the first pipe mouth.

In some embodiments, the second section of the adaptor is positioned within the open mouth of the first pipe, and the adaptor is selected.

In some embodiments, the first and second pipes are about horizontal or vertical.

In some embodiments, the first and second pipes are angled relative to each other.

In some embodiments, the presently disclosed subject matter is directed to a kit comprising a pipe alignment device that includes a housing defined by a first segment comprising a front face, an opposed rear face, and a length therebetween. The housing also includes a second segment comprising a front face, an opposed rear face, and a length therebetween, wherein the second segment front face is in direct contact with the first segment rear face. The housing further includes a channel that spans an interior of the housing from the first segment front face to the second segment rear face. The device comprises a laser positioned with the channel, the laser comprising a beam output positioned adjacent to the first segment front face. The device also includes a plurality of adaptors, each adaptor defined by a first section comprising a front face, an opposed rear face, and a length therebetween. Each adaptor also includes a second section comprising a front face, and opposed rear face, and a length therebetween, wherein the second section front face is in direct contact with the first section rear face. The first segment, second segment, first section, and second section each comprise a diameter, the first segment diameter being greater than the second segment diameter, the first section diameter being greater than the second section diameter. The plurality of adaptors each comprise a second section diameter greater than the housing second section diameter. The plurality of adaptors each comprise a range of second section diameters.

### BRIEF DESCRIPTION OF THE DRAWINGS

FIG. 1a is a perspective view of a device housing comprising a laser in accordance with some embodiments of the presently disclosed subject matter.

FIG. 1b is a perspective view of a device housing and laser comprising an adaptor in accordance with some embodiments of the presently disclosed subject matter.

FIG. 2a is a perspective view of a device housing in accordance with some embodiments of the presently disclosed subject matter.

FIG. 2b is a side plan view of a device housing in accordance with some embodiments of the presently disclosed subject matter.

FIGS. 2c and 2d are top plan views of device housings in accordance with some embodiments of the presently disclosed subject matter.

FIG. 2e is a bottom plan view of a device housing in accordance with some embodiments of the presently disclosed subject matter.

FIG. 3a is a side plan view of a device laser in accordance with some embodiments of the presently disclosed subject matter.

FIG. 3b is a perspective view of a device housing comprising a laser in accordance with some embodiments of the presently disclosed subject matter.

FIGS. 3c and 3d are fragmentary front plan views of device housings comprising a laser in accordance with some embodiments of the presently disclosed subject matter.

FIG. 4a is a side plan view of a device housing being inserted onto a pipe mouth in accordance with some embodiments of the presently disclosed subject matter.

FIG. 4b is a side plan view of a housing inserted on a pipe mouth in accordance with some embodiments of the presently disclosed subject matter.

FIG. 4c is a side plan view of a laser emitting a light from a pipe onto a wall in accordance with some embodiments of the presently disclosed subject matter.

FIG. 4d is a top plan view of a housing comprising a plurality of laser position adjusters in accordance with some embodiments of the presently disclosed subject matter.

FIG. 5a is front plan view of a device adaptor in accordance with some embodiments of the presently disclosed subject matter.

FIG. 5b is a perspective view of a device adaptor in accordance with some embodiments of the presently disclosed subject matter.

FIGS. 5c and 5d are top plan views of device adaptors in accordance with some embodiments of the presently disclosed subject matter.

FIGS. 6a and 6b are side plan views of the insertion of an adaptor onto a housing in accordance with some embodiments of the presently disclosed subject matter.

FIG. 7a is a side plan view of a housing and adaptor inserted into a pipe mouth in accordance with some embodiments of the presently disclosed subject matter.

FIG. 7b is a side plan view of a housing and adaptor inserted into a pipe mouth, with a laser emitting a beam onto a wall in accordance with some embodiments of the presently disclosed subject matter.

FIG. 8 is a schematic of a kit in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments+/−20%, in some embodiments+/−10%, in some embodiments+/−5%, in some embodiments+/−1%, in some embodiments+/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

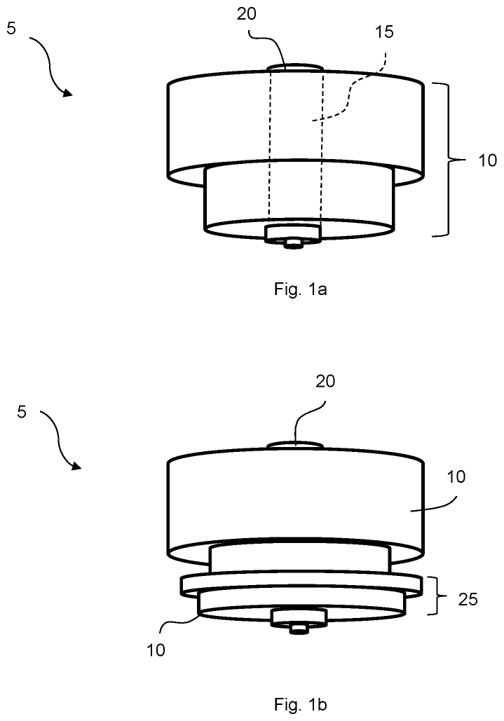

The presently disclosed subject matter is generally directed to an alignment device that can be used in a wide variety of situations, such as (but not limited to) the installation of pipes, conduits, and drainage fittings. As illustrated in FIG. 1a, device 5 comprises housing 10 defined by central channel 15. Recessed laser 20 passes through the housing central channel and is configured to emit a beam of light in a straight or angled line, visible to the user. The laser beam can be used to accurately position pipes, drainage fittings, and the like. In some embodiments, the device includes one or more adaptors 25 of various sizes that can releasably attach to housing 10, as shown in FIG. 1b. The adaptor functions a connector, selected to fit a desired pipe size to allow for proper positioning of the device. Thus, in use, the housing and/or a portion of the adaptor can fit into an open end of a pipe such that the laser beam emits a beam of light indicating a projected location for a connecting pipe or conduit. In this way, device 5 visually assists the user in determining a path for assembly of a piping system.

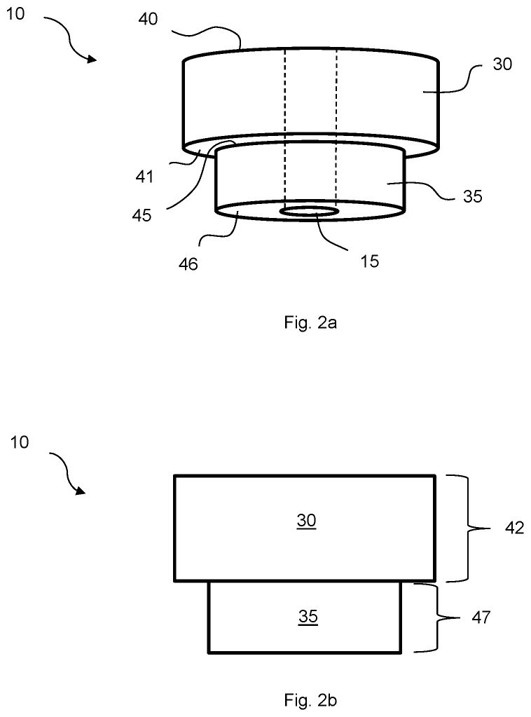

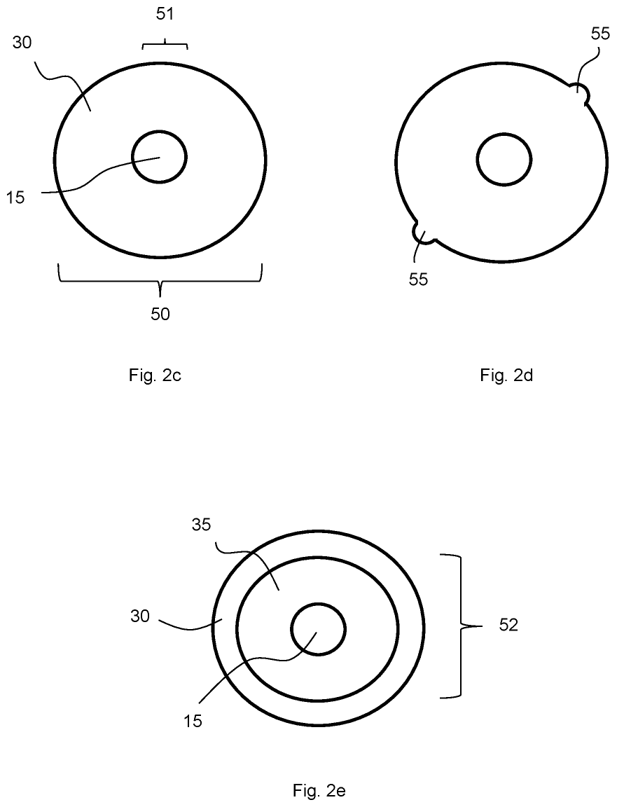

FIGS. 2a and 2b illustrate one embodiment of housing 10. As shown, the housing includes first segment 30 and second segment 35. The first segment incudes front face 40 and opposed rear face 41 with first length 42 therebetween. First length 42 can be about 0.5-2 inches (e.g., at least/no more than about 0.5, 0.6, 0.7, 0.8, 0.9, 1, 1.1, 1.2, 1.3, 1.4, 1.5, 1.6, 1.7, 1.8, 1.9, or 2 inches). Similarly, second segment 35 includes front face 45 and opposed rear face 46 with second length 47 therebetween. Second length 47 can be about 0.3-2 inches (e.g., at least/no more than about 0.3, 0.4, 0.5, 0.6, 0.7, 0.8, 0.9, 1, 1.1, 1.2, 1.3, 1.4, 1.5, 1.6, 1.7, 1.8, 1.9, or 2 inches). It should be appreciated that first and second lengths 42, 47 are not limited and can be configured outside the ranges given herein.

In some embodiments, the first and second segments are configured to be cylindrical in shape, allowing the second segment to fit within the interior of a pipe open end, as described below. However, the presently disclosed subject matter is not limited, and first or second segments 30, 35 can have any desired cross-sectional shape, such as (but not limited to) circular, oval, square, rectangular, triangular, octagonal, hexagonal, pentagonal, and the like.

Further, first length 42 can be greater than second length 47 as shown in FIG. 2b. Thus, the first segment can have a length that is about 1-60 percent larger than the second segment length (e.g., at least/no more than about 1, 5, 10, 15, 20, 25, 30, 35, 40, 45, 50, 55, or 60 percent).

FIG. 2c is a top plan view of housing 10, illustrating first segment 30 and channel 15 that passes through the length of the housing. The first segment includes diameter 50 of about 2-6 inches (e.g., at least/no more than about 2, 2.25, 2.5, 2.75, 3, 3.25, 3.5, 3.75, 4, 4.25, 4.5, 4.75, 5, 5.25, 5.5, 5.75, or 6 inches). The term “diameter” refers to the longest straight-line distance that passes through the center of an element face.

FIG. 2c further illustrates channel 15 that passes through the length of the housing. Channel 15 can have diameter 51 of about 0.2-1 inches, sized and shaped to accommodate laser 20. Thus, channel 15 can have a diameter of about 0.2, 0.3, 0.4, 0.5, 0.6, 0.7, 0.8, 0.9, or 1 inch. Channel diameter 51 should be configured larger than the diameter of laser 20 (e.g., about 0.1, 0.5, 1, 5, 10, or 15 percent larger). The channel can further have a length of about 0.8-4 inches (e.g., at least/no more than about 0.8, 1, 1.25, 1.5, 1.75, 2, 2.25, 2.5, 2.75, 3, 3.25, 3.5, 3.75, or 4 inches). The channel length is the length that spans first segment top face 40 to second segment rear face 46. It should be appreciated that the channel diameter and length are not limited to the ranges given herein and can be constructed with any desired dimensions.

Channel 15 further is shaped to accommodate laser 20. For example, in some embodiments, the channel has a circular cross-sectional shape to receive the similarly shaped laser. However, the channel can include any suitable cross-sectional shape.

FIG. 2d illustrates that in some embodiments, first segment 30 can include one or more extensions 55 positioned about the exterior surface of the segment, acting as gripping elements. The extensions can include (but are not limited to) ridges, indentations, raised regions, plateaus, and the like. The first segment can include any desired number of extensions, such as about 0-10 or more.

FIG. 2e is a bottom plan view of the housing of FIG. 2a, illustrating first and second segments 30, 35 and channel 15 that spans the length of the housing. Second segment 35 includes diameter 52 of about 1.5-5.5 inches (e.g., at least/no more than about 1.5, 1.75, 2, 2.25, 2.5, 2.75, 3, 3.25, 3.5, 3.75, 4, 4.25, 4.5, 4.75, 5, 5.25, or 5.5 inches). However, the diameters of the first and second segments are not limited and can be configured outside the given ranges.

The first and second segments can be permanently or releasably attached together. For example, welding, adhesive, magnets, screws, bolts, fasteners, and the like can be used to attach the first and second segments. Alternatively, the first and second segments can be constructed as a single unit in some embodiments.

Housing 10 can be constructed from any desired material, such as (but not limited to) metal (e.g., stainless steel, aluminum), rubber, wood, plastic, or combinations thereof.

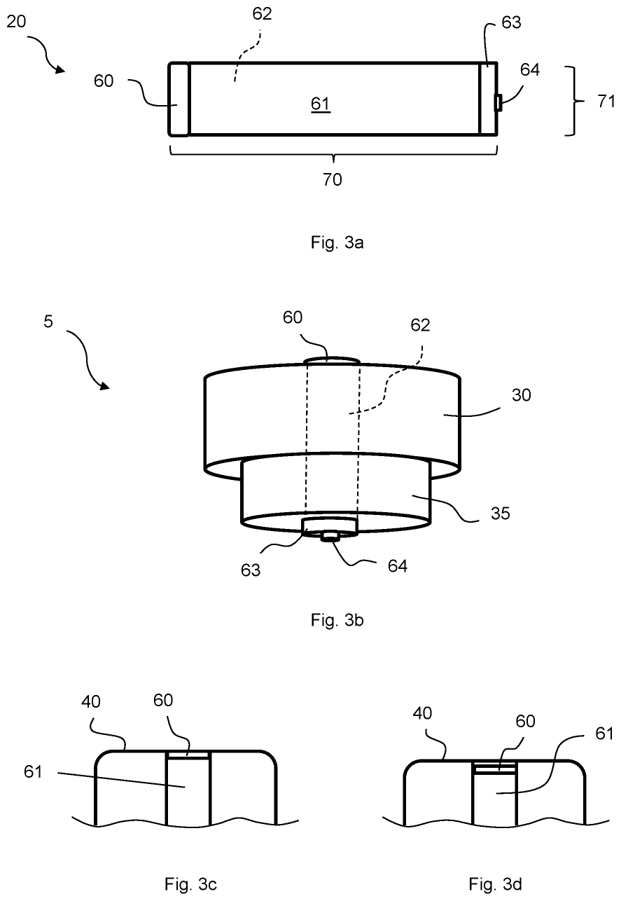

Device 5 further includes laser 20 positioned within housing channel 15. The term “laser” refers to any of a variety of devices that emit one or more discrete frequencies of amplified light. For example, laser 20 can emit visible light, which can be in the form of a laser diode or circuit, a light emitting diode (LED), or other optically transmitting devices. FIG. 3a illustrates one embodiment of laser 20 comprising beam output 60 through which the light leaves the laser. The laser also include body 61 with interior 62 that houses the power source and circuitry of the laser, which are well known in the art. Laser 20 also includes cap 63 that can be removed as desired by the user, such as to replace the battery or make repairs. Cap 63 also functions to prevent dust or other foreign objects from contacting the battery or internal circuitry. The laser further comprises on/off switch 64 that can activate and deactivate the laser light on demand. The on/off switch can be positioned at any location on the laser that is accessible to the user. Further, laser 20 can have any desired configuration, and is not limited to the embodiments illustrated in the Figures.

Laser 20 can have length 70 of about 0.8-4.5 inches (e.g., at least/no more than about 0.8, 1, 1.25, 1.5, 1.75, 2, 2.25, 2.5, 2.75, 3, 3.25, 3.5, 3.75, 4, 4.25, or 4.5 inches). The laser further includes diameter 71 of about 0.1, 0.2, 0.3, 0.4, 0.5, 0.6, 0.7, 0.8, 0.9, or 1 inch. The laser diameter should be smaller than the diameter of channel 15 to retain the laser snugly but securely within the housing. In some embodiments, the similarity in shape and/or size between the laser and channel 15 is sufficient to securely retain the laser within the channel. However, the use of adhesives and the like can be used to ensure that laser 20 does not become dislodged from the housing, such as if device 5 is inadvertently dropped.

FIG. 3b illustrates one embodiment of laser 20 configured within housing channel 15. As shown, beam output 60 is positioned adjacent to top face 40 of the first housing segment. In some embodiments, the output extends from the housing as shown in FIG. 3b. However, in some embodiments, the beam output is flush with top face 40 or recessed to provide protection for the laser, as shown in FIGS. 3c and 3d.

Laser 20 can be centrally aligned within the channel. In some embodiments, the laser is permanently attached within the interior of the channel in a leveled configuration. In this way, the user is ensured that the laser beam is level during use.

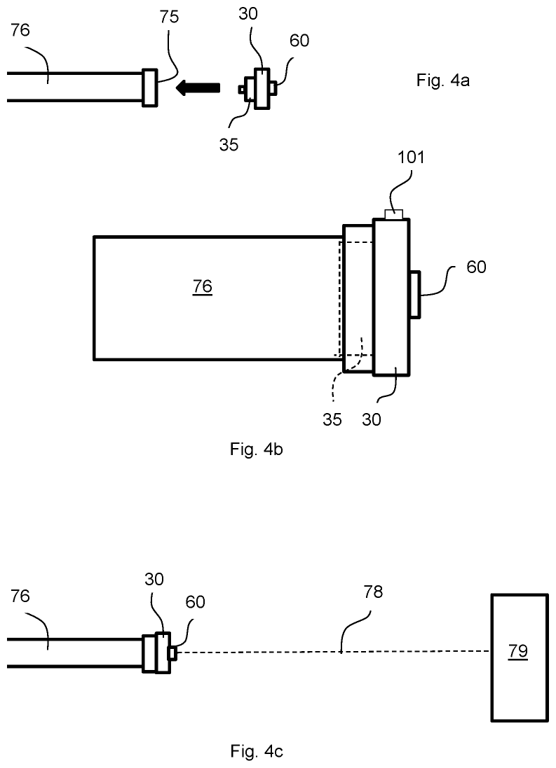

In use, housing 10 can at least partially fit within the open end of a pipe or fitting (e.g., a 1½ inch PVC fitting), as shown in FIG. 4a. Specifically, second segment 35 can be positioned within open mouth 75 of pipe 76. First segment 30 has a diameter too wide to fit within the pipe mouth, as shown in FIG. 4b. In this way, the housing is maintained within the pipe open mouth, allowing the laser output to direct beam of light 78 to a projected area (e.g., wall 79), as shown in FIG. 4c. The first segment is retained on the exterior of the pipe and can be used to insert and/or remove the housing from the pipe mouth (e.g., applying pressure to remove, screwing or unscrewing the second segment from the pipe mouth, etc.).

In some embodiments, the output directs a beam of light in the same plane of the direction of the pipe, such as by being self-leveled within channel 15 or including a leveling device 101. However, in some embodiments, the beam of light can be adjusted to account for the angling of pipes in an upward or downward direction. This can be accomplished though manual or automatic adjusters 77 that can move one end of the laser in a desired direction (e.g., up, down, left, right, or angled from center), as shown in FIG. 4d. Thus, in some embodiments, the device remains seated within the pipe, but the laser within the channel can be angled as desired (e.g., by modifying the adjusters in a desired direction to shift the laser output). Adjusters 77 can have any desired configuration, such as set screws, rods, and the like. The orientation of laser 40 within the channel can be controlled through manipulation of the adjusters. For instance, one adjuster can be rotated or moved toward/away from the laser to move the laser along the channel axis (e.g., to the right of center, left of center, above center, below center). In this way, the beam from laser 20 can be level or offset for a desired pipe fitting application.

Any mechanism can be used to releasably retain second segment 35 within the open mouth of a pipe or fitting. For example, snap fit, pressure fit, threading (e.g., the exterior surface of the second segment can cooperate with interior pipe mouth threads), fasteners, set screws, and the like can be used.

Housing 10 and laser 20 therefore provide a guide for leveling and/or completing construction on piping systems (as well as any other projects). The device visually assists the user in determining a path for assembling the piping system.

After the user completes the job or no longer needs the laser light, the user can detach the housing from pipe mouth 75 by reversing the steps set forth above (e.g., removing the housing second segment from pipe mouth 75). In some embodiments, screw threads on the pipe mouth and/or housing can be reversed. The housing can then be stored for later use.

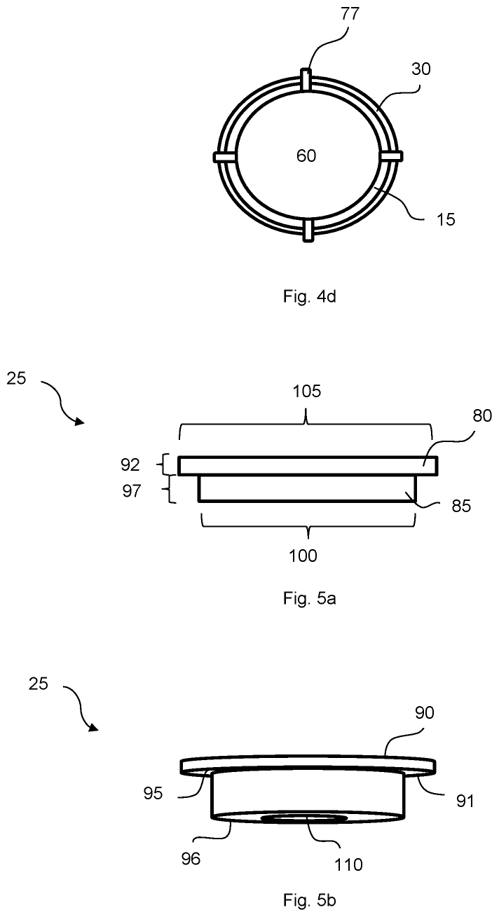

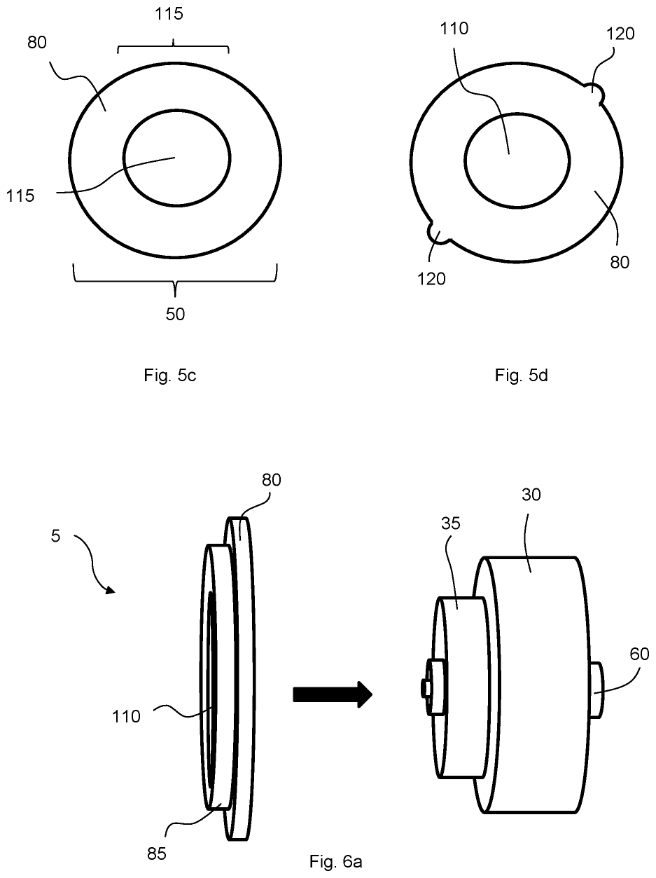

The disclosed device can further include a plurality of adaptors configured to adapt device 5 for use with a wide variety of pipe sizes. In some embodiments, an adapter can be screwed over or otherwise releasably attached to the proximal end of second segment 35 of the main body to adapt the device to fit various types of pipe fittings. FIGS. 5a and 5b illustrate one embodiment of adaptor 25 comprising first section 80 and second section 85. The first adaptor section includes front face 90 and opposed rear face 91 with first length 92 therebetween. First length 92 can be about 0.1-0.8 inches (e.g., at least/no more than about 0.1, 0.2, 0.3, 0.4, 0.5, 0.6, 0.7, or 0.8 inches). Similarly, second section 85 includes front face 95 and opposed rear face 96 with second length 97 therebetween. Second length 97 can be about 0.2-1 inches (e.g., at least/no more than about 0.2, 0.3, 0.4, 0.5, 0.6, 0.7, 0.8, 0.9, or 1 inch). It should be appreciated that first and second lengths 92, 97 are not limited and can be configured outside the ranges given herein.

First section 80 can have diameter 105 of about 3-6 inches (e.g., at least/no more than about 3, 3.25, 3.5, 3.75, 4, 4.25, 4.5, 4.75, 5, 5.25, 5.5, 5.75, or 6 inches). Similarly, the second section can include diameter 100 of about 2-5 inches (e.g., at least/no more than about 2, 2.25, 2.5, 2.75, 3, 3.25, 3.5, 3.75, 4, 4.25, 4.5, 4.75, or 5 inches). However, it should be appreciated that the diameter ranges of adaptor first and second sections 80, 85 are not limited to the ranges given herein.

In some embodiments, the first and second adaptor sections are configured to be cylindrical in shape. However, the presently disclosed subject matter is not limited, and first or second sections 80, 85 can have any desired cross-sectional shape, such as (but not limited to) circular, oval, square, rectangular, triangular, octagonal, hexagonal, pentagonal, and the like.

Adaptor 25 includes central bore 110 that passes through the first and second sections, as shown in the top plan view of FIG. 5c. In some embodiments, central bore 110 includes diameter 115 of about 1-4 inches (e.g., at least/no more than about 1, 1.25, 1.5, 1.75, 2, 2.25, 2.5, 2.75, 3, 3.25, 3.5, 3.75, or 4 inches). The adaptor central bore should be configured with a diameter greater than the diameter of the housing second section 35. In this way, the second segment of the housing can pass through the central bore when the adaptor is in use. Thus, central bore 110 is sized and shaped to accommodate housing second segment 35. In some embodiments, the interior of the central bore includes threading that mates with external threading present on the second segment, although any connection mechanism can be used.

FIG. 5d illustrates that in some embodiments, adaptor first section 80 can include one or more extensions 120 positioned about the exterior surface of the section, acting as gripping elements. The extensions can include (but are not limited to) ridges, indentations, raised regions, plateaus, and the like. The first section can include any desired number of extensions, such as about 0-10 or more.

The first and second adaptor sections can be permanently or releasably attached together. For example, welding, adhesive, magnets, screws, bolts, fasteners, and the like can be used. Alternatively, the first and second adaptor sections can be constructed as a single unit in some embodiments.

Adaptor 25 can be constructed from any desired material, such as (but not limited to) metal (e.g., stainless steel, aluminum), rubber, wood, plastic, or combinations thereof.

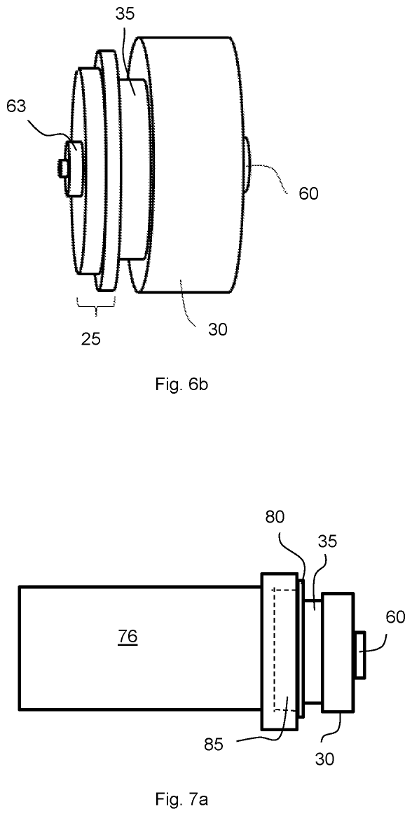

In some embodiments, the disclosed system includes a kit comprising a variety of differently sized adaptors to allow housing 10 to be used with many different sizes of pipes or fittings. Thus, when pipe mouth is larger than the diameter of the housing second segment, adaptor 25 can be releasably attached to the housing. Particularly, housing section segment 35 can pass through the adaptor central bore (e.g., using threaded attachment or any other conventional mechanism), as shown in FIGS. 6a and 6b. In this way, the laser cap is accessible to turn the laser on or off.

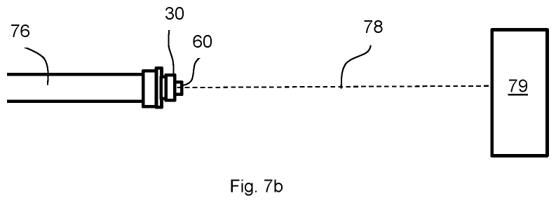

Adaptor second section 85 can then be inserted into open mouth 75 of pipe 76 (e.g., through mating threads or other releasable attachment). Adaptor first segment 80 has a diameter too large to fit within the pipe mouth, as shown in FIG. 7a. In this way, the housing and adaptor are maintained within the pipe open mouth, allowing the laser output to direct beam of light 78 to a projected area (e.g., wall 79), as shown in FIG. 7b. The laser beam identifies the location where a hole, pipe, or connection should be made.

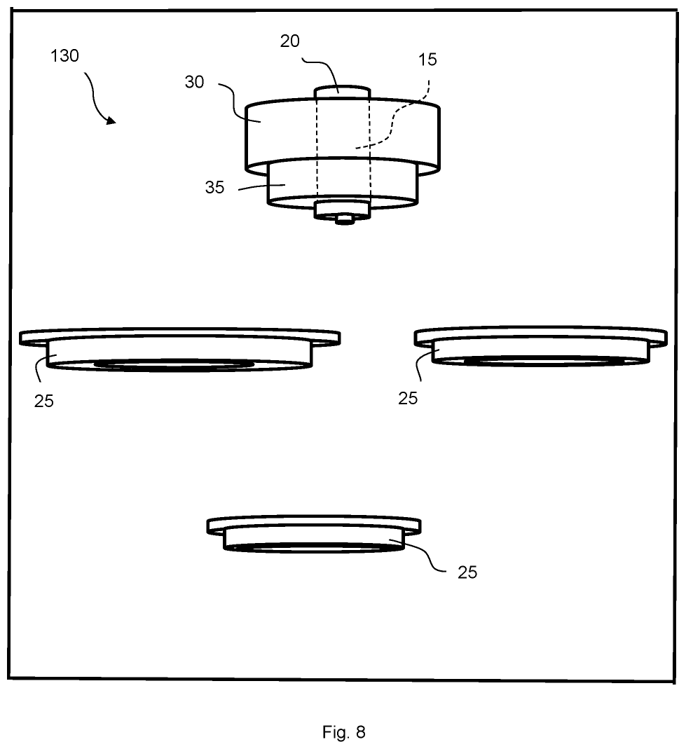

After the user has finished using laser 20, the adaptor and housing can be removed from the pipe or fitting mouth. The adaptor can then be removed from housing 10. In some embodiments, the kit includes a carrying or storage case to accommodate the housing and a plurality of adaptors that have different diameters to accommodate pipes and fittings of various sizes. The different adaptors can be selected as needed for a particular job. In this way, the disclosed kit can accommodate any sized pipe that the user comes into contact with. One embodiment of kit 130 is illustrated in FIG. 8. In some embodiments, the kit can include at least one set of user instructions.

The disclosed device and system offer many advantages over the prior art. For example, device 5 acts as a laser alignment tool when inserted into the end of a pipe. In use, the laser will direct a laser point onto the surface that needs to be penetrated (e.g., cutting through walls, roofs, crawl space walls, etc.) or into the center of another pipe that the new pipe needs to be tied into.

Advantageously, the device removes all of the guesswork for pipe alignment, providing a clear line of sight. In this way, errors are reduced.

The disclosed device can be used by one person to align a pipe, thereby freeing other workers to be more productive.

The device is easy to use, allowing novice users to complete a job much more quickly and with fewer mistakes.

The device further provides speed and convenience for experienced users.

The disclosed kit can allow a user to employ the disclosed device with virtually any sized pipe, so long as the correct sized adaptor is available.

What is claimed is:

1. A pipe alignment device comprising:
a housing defined by:
a first segment comprising a front face, an opposed rear face, and a length therebetween;
a second segment comprising a front face, an opposed rear face, and a length therebetween, wherein the second segment front face is in direct contact with the first segment rear face;
a channel that spans an interior of the housing from the first segment front face to the second segment rear face;
a laser positioned with the channel, the laser comprising a beam output positioned adjacent to the first segment front face;
an adaptor defined by:
a first section comprising a front face, an opposed rear face, and a length therebetween;
a second section comprising a front face, and opposed rear face, and a length therebetween, wherein the second section front face is in direct contact with the first section rear face;
a central bore that an interior of the adaptor from the first section front face to the second section rear face;
wherein the first segment, second segment, first section, and second section each comprise a diameter, the first segment diameter being greater than the second segment diameter, the first section diameter being greater than the second section diameter.

2. The pipe alignment device of claim 1, further comprising a level.

3. The pipe alignment device of claim 1, wherein the laser is leveled within the housing channel.

4. The pipe alignment device of claim 1, wherein the second section diameter is greater than the second segment diameter.

5. The pipe alignment device of claim 1, wherein the housing first length is about 0.5 to 2 inches and the housing second length is about 0.3 to 2 inches.

6. The pipe alignment device of claim 1, wherein the first segment, second segment, first section, and second section are configured with a cylindrical shape.

7. The pipe alignment device of claim 1, wherein the channel comprises a diameter of about 0.2 to 1 inches and a length of about 0.8-4 inches.

8. The pipe alignment device of claim 1, wherein the channel comprises one or more adjusters configured to adjust the orientation of the laser within the channel.

9. The pipe alignment device of claim 1, wherein the adaptor first length is about 0.1-0.8 inches.

10. The pipe alignment device of claim 1, wherein the adaptor second length is about 0.2-1 inches.

11. The pipe alignment device of claim 1, wherein the adaptor first section has a diameter of about 3-6 inches.

12. The pipe alignment device of claim 1, wherein the adaptor second section has a diameter of about 2-5 inches.

13. The pipe alignment device of claim 1, wherein the central bore comprises a diameter of about 1-4 inches.

14. A method of installing a pipe or tubing, the method comprising:
positioning the housing second segment of the pipe alignment device of claim 1 into the open mouth of a first pipe;
powering the laser, whereby a laser beam is projected onto a surface in front of the first pipe;
positioning a second pipe in line with the laser beam, such that the first and second pipes are in alignment.

15. The method of claim 14, wherein the second segment cooperates with the open mouth of the first pipe to retain the device within the first pipe mouth.

16. The method of claim 14, wherein the second segment comprises an adaptor, the adaptor defined by a second segment that cooperates with the open mouth of the first pipe to retain the device within the first pipe mouth.

17. The method of claim 14, wherein the second section of the adaptor is positioned within the open mouth of the first pipe, and the adaptor is selected.

18. The method of claim 14, wherein the first and second pipes are about horizontal or vertical.

19. The method of claim 14, wherein the first and second pipes are angled relative to each other.

20. A kit comprising:
a pipe alignment device including:
a housing defined by:
a first segment comprising a front face, an opposed rear face, and a length therebetween;
a second segment comprising a front face, an opposed rear face, and a length therebetween, wherein the second segment front face is in direct contact with the first segment rear face;
a channel that spans an interior of the housing from the first segment front face to the second segment rear face; and
a laser positioned with the channel, the laser comprising a beam output positioned adjacent to the first segment front face;
a plurality of adaptors, each adaptor defined by:
a first section comprising a front face, an opposed rear face, and a length therebetween;
a second section comprising a front face, and opposed rear face, and a length therebetween, wherein the second section front face is in direct contact with the first section rear face;
wherein the first segment, second segment, first section, and second section each comprise a diameter, the first segment diameter being greater than the second segment diameter, the first section diameter being greater than the second section diameter; and
wherein the plurality of adaptors each comprise a second section diameter greater than the housing second section diameter; and
wherein the plurality of adaptors comprise a range of second section diameters.
